(19) United States
(12) Patent Application Publication
(10) Pub. No.: US 2025/0201250 A1
(43) Pub. Date: Jun. 19, 2025

(54) SOUND CLASSIFICATION APPARATUS, SOUND CLASSIFICATION METHOD, AND COMPUTER-READABLE RECORDING MEDIUM

(71) Applicant: NEC Corporation, Minato-ku, Tokyo (JP)

(72) Inventors: Yuko NAKANISHI, Tokyo (JP); Akira GOTOH, Tokyo (JP); Shuji KOMEIJI, Tokyo (JP); Daichi NISHII, Tokyo (JP); Yuka ENJOJI, Tokyo (JP)

(73) Assignee: NEC Corporation, Minato-ku, Tokyo (JP)

(21) Appl. No.: 18/845,977

(22) PCT Filed: Mar. 17, 2022
(86) PCT No.: PCT/JP2022/012326

§ 371 Date: Sep. 11, 2024

(51) Int. Cl. G10L 17/06; G06N 20/00; G10L 17/02; G10L 17/04

(52) U.S. Cl. CPC G10L 17/06; G06N 20/00; G10L 17/02; G10L 17/04

(57) ABSTRACT

A sound classification apparatus includes: a learning model classification unit that inputs sound data to be classified into a machine learning model generated by machine learning using sound data and teacher data that serve as training data, and outputs a classification result using an output result from the machine learning model; a condition classification unit that classifies the sound data to be classified, based on information registered in advance, and outputs a classification result; and a sound classification unit 12 that classifies the sound data to be classified, based on the classification result of the learning model classification means and the classification result of the condition classification means.

### TECHNICAL FIELD

The present disclosure relates to a sound classification apparatus and a sound classification method for classifying sounds such as human voices and environmental sounds, and further relates to a computer-readable recording medium having recorded thereon a program for realizing the sound classification apparatus and the sound classification method.

### BACKGROUND ART

In recent years, a technique for classifying sounds such as environmental sounds and voices have been proposed. According to such a technique for classifying sounds (hereinafter referred to as a “sound classification technique”), for example, it is possible to determine whether a sound that is input is a human voice or noise, without human intervention. Furthermore, according to the sound classification technique, it is possible to determine attributes (e.g., age, gender) of the person whose voice is input, and further, the qualities of the voice. The sound classification technique is expected to be used in various fields.

Patent Document 1 discloses an example of the sound classification technique. In the sound classification technique disclosed in Patent Document 1, first, machine learning is performed using voice data and correct labels as training data to construct a classification model. Next, classification is performed by inputting the sound data to be classified into the constructed classification model.

### LIST OF RELATED ART DOCUMENTS

### Patent Document

Patent Document 1: Japanese Patent Laid-Open Publication No. 2021-144221

### SUMMARY OF INVENTION

### Problems to be Solved by the Invention

In the technique disclosed in Patent Document 1, sound classification is performed based only on the output results of the classification model, and thus in order to improve the classification accuracy, it is necessary to improve the performance of the classification model. However, in order to improve the performance of a classification model, it is necessary to prepare as much diverse training data as possible, but preparing a large amount of diverse training data is not easy.

An example object of the present disclosure is to provide a sound classification apparatus, a sound classification method, and a computer-readable recording medium that can improve sound classification accuracy, independently of the performance of the classification model.

### Means for Solving the Problems

In order to achieve the above-described object, a sound classification apparatus according to an example aspect of the present disclosure includes:

a learning model classification unit that inputs sound data to be classified into a machine learning model generated by machine learning using sound data and teacher data that serve as training data, and outputs a classification result using an output result from the machine learning model;

a condition classification unit that classifies the sound data to be classified, based on information registered in advance, and outputs a classification result; and

a sound classification unit that classifies the sound data to be classified, based on the classification result of the learning model classification means and the classification result of the condition classification means.

In order to achieve the above-described object, a sound classification method according to an example aspect of the present disclosure includes:

inputting sound data to be classified into a machine learning model generated by machine learning using sound data and teacher data that serve as training data, and outputting a classification result using an output result from the machine learning model;

classifying the sound data to be classified, based on information registered in advance, and outputting a classification result; and

classifying the sound data to be classified, based on the classification result of machine learning model and the classification result using the information.

In order to achieve the above-described object, a computer readable recording medium according to an example aspect of the present disclosure is a computer readable recording medium that includes recorded thereon a program,

the program including instruction that cause a computer to carry out:

inputting sound data to be classified into a machine learning model generated by machine learning using sound data and teacher data that serve as training data, and outputting a classification result using an output result from the machine learning model;
classifying the sound data to be classified, based on information registered in advance, and outputting a classification result; and
classifying the sound data to be classified, based on the classification result of machine learning model and the classification result using the information.

### Advantageous Effects of the Invention

As described above, according to the present disclosure, it is possible to improve sound classification accuracy, independently of the performance of the classification model.

### BRIEF DESCRIPTION OF THE DRAWINGS

FIG. 1 is a configuration diagram illustrating an overview configuration of the sound classification apparatus according to the example embodiment.

FIG. 2 is a configuration diagram specifically illustrating the configuration of the sound classification apparatus 10 according to the example embodiment.

FIG. 3 is a flowchart illustrating the operations of the sound classification apparatus according to the example embodiment.

FIG. 4 is a diagram illustrating an example of classification results registered in the database in the specific example 1.

FIG. 5 is a diagram illustrating an example of classification results registered in the database.

FIG. 6 is a block diagram illustrating an example of a computer that realizes the sound classification apparatus according to the example embodiment.

### EXAMPLE EMBODIMENT

### Example Embodiment

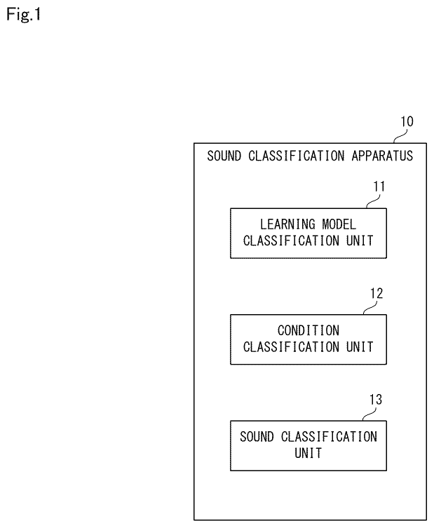

Hereinafter, a sound classification apparatus according to an example embodiment will be described with reference to FIGS. 1 to 6.

### [Apparatus Configuration]

First, an overview configuration of the sound classification apparatus according to the example embodiment will be described using FIG. 1. FIG. 1 is a configuration diagram illustrating an overview configuration of the sound classification apparatus according to the example embodiment.

A sound classification apparatus 10 according to the example embodiment illustrated in FIG. 1 is an apparatus for classifying various kinds of sounds such as human voices and environmental sounds. As illustrated in FIG. 1, the sound classification apparatus 10 includes a learning model classification unit 11, a condition classification unit 12, and a sound classification unit 13.

The learning model classification unit 11 inputs sound data to be classified into a machine learning model, and outputs a classification result using an output result from the machine learning model. The machine learning model is a classification model generated by machine learning using sound data and teacher data that serve as training data.

The condition classification unit 12 classifies the sound data to be classified, based on information registered in advance (hereinafter referred to as “registration information”), and outputs the classification result. The sound classification unit 13 classifies the sound data to be classified, based on the classification result from the learning model classification unit 11 and the classification result from the condition classification unit 12.

In this manner, in the example embodiment, in addition to the classification using the classification model (machine learning model), classification based on information registered in advance is performed, and these classifications are combined for use in performing final classification. For this reason, even if a large amount of diverse training data cannot be prepared, detailed classification can be performed. That is, according to the example embodiment, independently the performance of the classification model, an improvement in the classification accuracy of sound can be achieved.

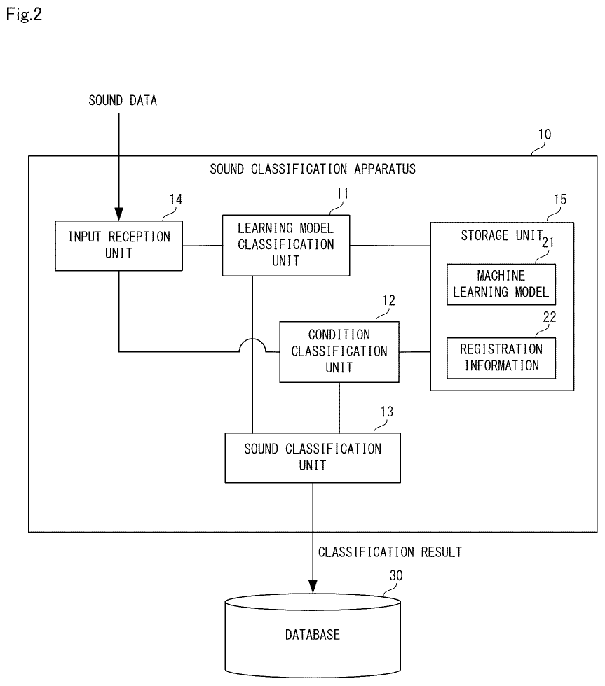

Next, the configuration and function of the sound classification apparatus 10 according to the example embodiment will be described in detail using FIG. 2. FIG. 2 is a configuration diagram specifically illustrating the configuration of the sound classification apparatus 10 according to the example embodiment.

As illustrated in FIG. 2, the sound classification apparatus 10 includes, in addition to the learning model classification unit 11, the condition classification unit 12, and the sound classification unit 13 described above, an input reception unit 14 and a storage unit 15.

The input reception unit 14 receives input of the sound data to be classified, and inputs the received sound data to the learning model classification unit 11 and the condition classification unit 12. The input reception unit 14 may extract the feature amount from the received sound data, and input only the extracted feature amount to the learning model classification unit 11 and the condition classification unit 12.

The storage unit 15 stores a machine learning model 21 used by the learning model classification unit 11 and registration information 22 used by the condition classification unit 12. In the example embodiment, the machine learning model 21 is a model for specifying the relationship between sound data and information characterizing the sound. Accordingly, the information characterizing the sound is used as the teacher data serving as the training data. For example, if the sound data is voice data, examples of information characterizing the sound (voice) include the name of the owner of the voice, the tone of the voice, the brightness of the voice, the clarity of the voice, and attributes (e.g., age, gender) of the owner of the voice. If the sound data is other than voice data, examples of the information include the type of sound (plosive sound, fricative sound, mastication sound, or stationary sound).

Here, specific examples of the training data will be listed below. Note that the feature amount of the sound may be used as the training data instead of the sound data.
Training data 1: (Voice data A, Voice actor A), (Voice data B, Voice actor B), (Voice data C, Voice actor C), etc.
Training data 2: (Voice data A, Clarity A), (Voice data B, Clarity B), (Voice data C, Clarity C), etc.
Training data 3: (Sound data A, Type A), (Sound data B, Type B), (Sound data C, Type C), etc.

If the training data 1 is used, the machine learning model, in response to the input of sound data, outputs, for each of voice actors A, B, C, etc., a probability (value from 0 to 1) that the input voice data corresponds thereto. In this case, the learning model classification unit 11 specifies the voice actor having the highest probability, and outputs the specified voice actor as the classification result.

If the training data 2 is used, since clarity is represented by a value from 0 to 1, the machine learning model, in response to the input of voice data, outputs a value corresponding to the input voice data as the clarity. In this case, the learning model classification unit 11 outputs, as the classification result, the value that is output as the clarity.

If the training data 3 is used, the machine learning model, in response to the input of sound data, output, for each of the types A, B, C, etc., a probability (value from 0 to 1) that the input sound data corresponds thereto. In this case, the learning model classification unit 11 specifies the type having the greatest probability, and outputs the specified type and the value of the probability as the classification result.

In the example embodiment, by inputting the sound data to be classified into the machine learning model 21, the learning model classification unit 11 outputs information characterizing the voice that corresponds to the sound data to be classified, specifically, the probability that corresponds to each of the features, as the classification result.

The registration information 22 is information that is registered in advance for classifying sound data. If the sound data is voice data, examples of the registration information 22 include the business performance of each individual, the address of each individual, the hobbies of each individual, the personality of each individual, and the loudness of voice of each individual. If the sound data is not voice data, examples of the registration information 22 include the location where each sound occurred, the volume of each sound, and the frequency of each sound.

In the example embodiment, the condition classification unit 12 refers to the sound data to be classified in the registration information 22, extracts the corresponding information, and outputs the extracted information as the classification result. Here, the sound data is assumed to be voice data. In this case, it is assumed that the voice data to be classified is given the identifier of the speaker and that the registration information 22 is registered for each identifier.

In this case, first, the condition classification unit 12 specifies, from the sound data to be classified, the identifier given to the sound data. Then, the condition classification unit 12 refers to the specified identifier in the registration information for each identifier, extracts the registration information corresponding to the specified identifier, and outputs the extracted registration information as the classification result.

The sound classification unit 13 outputs information in which the classification result of the learning model classification unit 11 and the classification result of the condition classification unit 12 are combined, as a result of classification. In the example embodiment, the result of classification that is output is registered in a database 30.

### [Apparatus Operations]

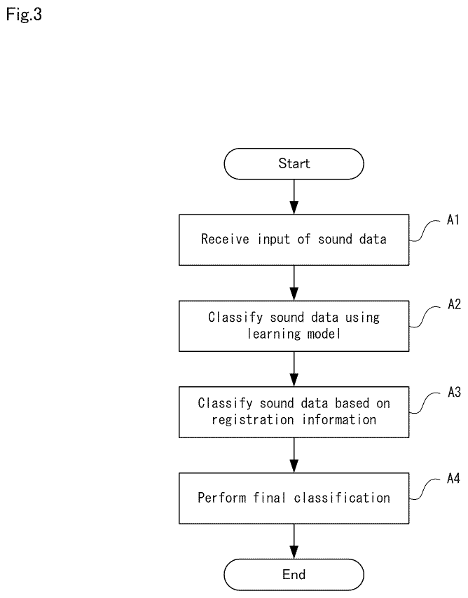

Next, the operations of the sound classification apparatus 10 according to the example embodiment will be described using FIG. 3. FIG. 3 is a flowchart illustrating the operations of the sound classification apparatus according to the example embodiment. In the following description, FIGS. 1 and 2 are referred to as appropriate. Also, in the example embodiment, by operating the sound classification apparatus 10, the sound classification method is implemented. Accordingly, the following description of the operations performed by the sound classification apparatus 10 is substituted for description of the sound classification method in the example embodiment.

As illustrated in FIG. 3, first, the input reception unit 14 receives input of the sound data to be classified (step A1). Also, the input reception unit 14 inputs the received sound data to the learning model classification unit 11 and the condition classification unit 12.

Next, the learning model classification unit 11 inputs, to the machine learning model 21, the sound data that was received in step A1, and outputs the classification result using the output result from the machine learning model (step A2).

Next, the condition classification unit 12 classifies the sound data that was received in step A1 based on the registration information 22, and outputs the classification result (step A3).

Then, the sound classification unit 13 classifies the sound data to be classified based on the classification result of step A2 and the classification result of step A3, and outputs the final classification result (step A4).

### SPECIFIC EXAMPLES

Here, a specific example 1 and a specific example 2 of processing performed by the sound classification apparatus 10 will be described. In the following specific examples 1 and 2, the sound data to be classified is assumed to be voice data.

### Specific Example 1

In the specific example 1, the machine learning model 21 has undergone machine learning using the above-described training data 1, and outputs the probabilities that the input voice data corresponds to each of the voice actor A, the voice actor B, the voice actor C, etc. (values from 0 to 1). Therefore, the learning model classification unit 11 specifies the voice actor having the highest probability from the output result, and outputs the name of the specified voice actor as the classification result.

Further, in the specific example 1, it is assumed that the region of residence (e.g., Kanto, Tohoku, Tokai) is registered as the registration information 22 for each identifier of an individual. The condition classification unit 12 specifies, from the voice data to be classified, the identifier of the speaker that is given to the voice data, refers to the specified identifier in the registration information 22, and outputs the name of the region corresponding to the specified identifier.

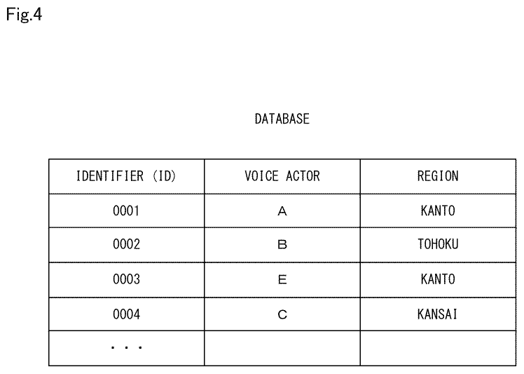

The sound classification unit 13 combines the name of the voice actor that was output from the learning model classification unit 11 and the name of the region that was output from the condition classification unit 12, and sets the combined names as the classification result. Examples of the classification result include “Voice actor A+Kanto” and “Voice actor B+Tohoku”. After that, the sound classification unit 13 outputs, as the final classification result, the name of the corresponding voice actor and the name of the region to the database 30. The database 30 registers the name of the voice actor and the name of the region in association with each other. FIG. 4 is a diagram illustrating an example of classification results registered in the database in the specific example 1.

### Specific Example 2

In the specific example 2, it is assumed that the machine learning model 21 has undergone machine learning using the above-described training data 2, and the learning model classification unit 11 outputs a value x₁ representing the clarity in response to the input of voice data to be classified.

Also, in the specific example 2, the business performance x₂ for each individual is registered as the registration information 22. In this case, the business performance is represented by normalizing the ranking to a value between 0 and 1. For example, if there are first to the 45th rankings of the business performance, “x₂=1” denotes first, “x₂=0.75” denotes 12th, and “x₂=0” denotes 45th.

The condition classification unit 12 specifies the identifier of the speaker that is given to the voice data from the voice data to be classified, and refers to the specified identifier in the business performance for each identifier, and outputs the business performance x₂ corresponding to the specified identifier.

The sound classification unit 13 inputs the output from the learning model classification unit 11 and the output from the condition classification unit 12 into Math. 1 below to calculate a classification score A. In Math. 1, w₁ and w₂ are weight coefficients. The values of the weight coefficients are set as appropriate according to the situation and the like.

$$A = {w}_{1} {x}_{1} + {w}_{2} {x}_{2} \qquad ( Math . 1 )$$

Then, the sound classification unit 13 divides the voice data to be classified into predetermined groups for each identifier according to the value of the calculated classification score A. For example, it is assumed that x₁=0.7, x₂=0.8, w₁=0.3, and w₂=0.7 are set. In this case, the classification score A=0.77. When it is assumed that a group 1 (A=0.7 or more and 1.0 or less), a group 2 (A=0.35 or more and less than 0.7), and a group 3 (A=0 or more and less than 0.35) are set, the sound classification unit 13 determines the voice data is the group 1.

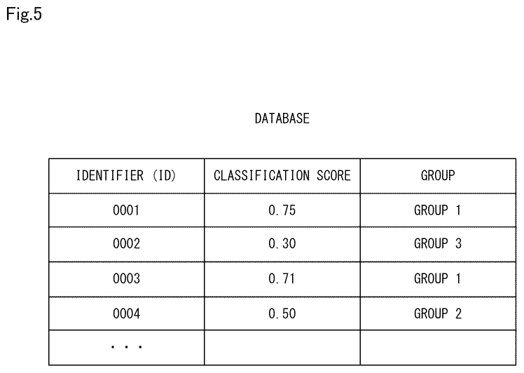

Thereafter, the sound classification unit 13 outputs the corresponding identifier and group number to the database 30 as the final classification result. The database 30 registers the identifier number and the group number in association with each other. FIG. 5 is a diagram illustrating an example of classification results registered in the database.

### Effects of Example Embodiment

As described above, in the example embodiment, in addition to classification by the machine learning model 21, classification based on the registration information 22 is also performed, and final classification is performed by combining these classifications. Accordingly, even if a large amount of diverse training data cannot be prepared, detailed classification can be performed. That is, according to the example embodiment, an improvement in accuracy of sound classification can be achieved independently the performance of classification model.

### [Program]

A program in the example embodiment is any program that causes a computer to execute steps A1 to A4 illustrated in FIG. 3. The sound classification apparatus 10 and the sound classification method in the present example embodiment can be realized, by installing the program in the computer and executing the installed program. In this case, the processor of the computer functions as the learning model classification unit 11, the condition classification unit 12, the sound classification unit 13, and the input reception unit 14 to perform processing.

In the example embodiment, the storage unit 15 may be realized by storing data files constituting the storage unit 15 in a storage device such as a hard disk provided in the computer, or may be realized by a storage device of another computer. The computer may be a general-purpose PC, a smartphone, or a tablet terminal device.

The program in the example embodiment may be executed by a computer system that is constructed of a plurality of computers. In this case, each computer may function as any of the learning model classification unit 11, the condition classification unit 12, the sound classification unit 13, and the input reception unit 14.

### [Physical Configuration]

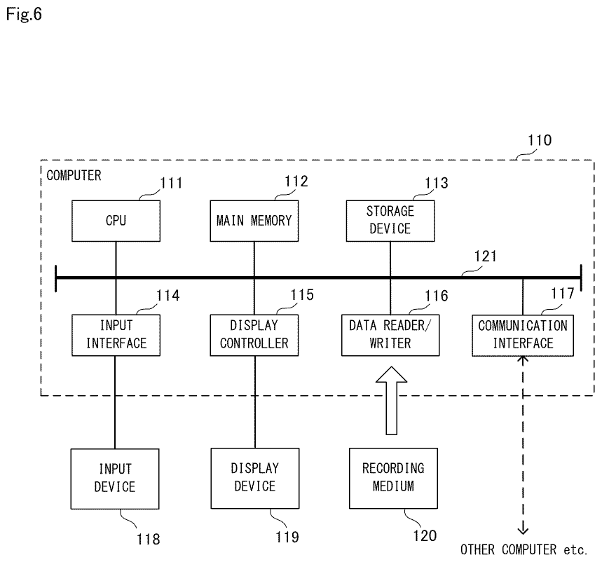

Using FIG. 6, the following describes a computer that realizes the matching apparatus 10 by executing the program according to the example embodiment. FIG. 6 is a block diagram illustrating an example of a computer that realizes the sound classification apparatus according to the example embodiment.

As illustrated in FIG. 6, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the first and second example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse.

The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the sound classification apparatus 10 according to the example embodiment can also be realized by using items of hardware such as electronic circuit correspond to the components rather than the computer in which the program is installed. Furthermore, a part of the sound classification apparatus 10 may be realized by the program, and the remaining part of the sound classification apparatus 10 may be realized by hardware.

A part or an entirety of the above-described example embodiment can be represented by (Supplementary Note 1) to (Supplementary Note 9) described below but is not limited to the description below.

### (Supplementary Note 1)

A sound classification apparatus includes:
a learning model classification unit that inputs sound data to be classified into a machine learning model generated by machine learning using sound data and teacher data that serve as training data, and outputs a classification result using an output result from the machine learning model;
a condition classification unit that classifies the sound data to be classified, based on information registered in advance, and outputs a classification result; and
a sound classification unit that classifies the sound data to be classified, based on the classification result of the learning model classification means and the classification result of the condition classification means.

### (Supplementary Note 2)

The sound classification apparatus according to supplementary note 1,
wherein the sound data is voice data, and an identifier of a speaker is given to the sound data to be classified, and
the condition classification unit specifies, from the sound data to be classified, the identifier given to the sound data, refers to the specified identifier in information registered in advance for each identifier, extracts the information corresponding to the specified identifier, and outputs the extracted information as the classification result.

### (Supplementary Note 3)

The sound classification apparatus according to supplementary note 2,
wherein the machine learning model is generated by machine learning using voice data and information characterizing voice,
the learning model classification unit outputs information characterizing voice, corresponding to the sound data to be classified, as the classification result, and
the sound classification unit outputs information in which the classification result of the learning model classification means and the classification result of the condition classification means are combined, as a result of the classification.

### (Supplementary Note 4)

A sound classification method comprising:
inputting sound data to be classified into a machine learning model generated by machine learning using sound data and teacher data that serve as training data, and outputting a classification result using an output result from the machine learning model;
classifying the sound data to be classified, based on information registered in advance, and outputting a classification result; and
classifying the sound data to be classified, based on the classification result of machine learning model and the classification result using the information.

### (Supplementary Note 5)

The sound classification method according to supplementary note 4,
wherein the sound data is voice data, and an identifier of a speaker is given to the sound data to be classified, and
in the classification based on the information registered in advance, the identifier given to the sound data is specified from the sound data to be classified, the specified identifier is referred to information registered in advance for each identifier, the information corresponding to the specified identifier is extracted, and the extracted information is output as the classification result.

### (Supplementary Note 6)

The sound classification method according to supplementary note 5,
wherein the machine learning model is generated by machine learning using voice data and information characterizing voice,
in the classification using the machine learning model, information characterizing voice, corresponding to the sound data to be classified, is output as the classification result, and
in the classification of the sound data to be classified, information in which the classification result of the machine learning model and the classification result using the information are combined, is output as a result of the classification.

### (Supplementary Note 7)

A computer-readable recording medium including a program recorded thereon, the program including instruction that cause a computer to carry out:
inputting sound data to be classified into a machine learning model generated by machine learning using sound data and teacher data that serve as training data, and outputting a classification result using an output result from the machine learning model;
classifying the sound data to be classified, based on information registered in advance, and outputting a classification result; and
classifying the sound data to be classified, based on the classification result of machine learning model and the classification result using the information.

### (Supplementary Note 8)

The computer-readable recording medium according to supplementary note 7,
wherein the sound data is voice data, and an identifier of a speaker is given to the sound data to be classified, and
in the classification using the information, from the sound data to be classified, the identifier given to the sound data is specified, the specified identifier is referred to information registered in advance for each identifier, the information corresponding to the specified identifier is extracted, and the extracted information is output as the classification result.

### (Supplementary Note 9)

The computer-readable recording medium according to supplementary note 8,
wherein the machine learning model is generated by machine learning using voice data and information characterizing voice,
in the classification using the machine learning model, information characterizing voice, corresponding to the sound data to be classified, is output as the classification result, and
in the classification of the sound data to be classified, information in which the classification result of the machine learning model and the classification result using the information are combined, is output as a result of the classification.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the present disclosure, it is possible to improve sound classification accuracy, independently of the performance of the classification model. The present disclosure is useful in a variety of fields where sound classification is required.

### REFERENCE SIGNS LIST

10 Sound classification apparatus
11 Learning model classification unit
12 Condition classification unit
13 Sound classification unit
14 Input reception unit
15 Storage unit
21 Machine learning model
22 Registration information
30 Database
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A sound classification apparatus comprising:
at least one memory storing instructions; and
at least one processor configured to execute the instructions to:
input sound data to be classified into a machine learning model generated by machine learning using sound data and teacher data that serve as training data, and output a classification result using an output result from the machine learning model;
classify the sound data to be classified, based on information registered in advance, and outputting a classification result; and
classify the sound data to be classified, based on the classification result of the learning model classification means and the classification result of the condition classification means.

2. The sound classification apparatus according to claim 1,
wherein the sound data is voice data, and an identifier of a speaker is given to the sound data to be classified, and
the one or more processors further specifies, from the sound data to be classified, the identifier given to the sound data, refers to the specified identifier in information registered in advance for each identifier, extracts the information corresponding to the specified identifier, and outputs the extracted information as the classification result.

3. The sound classification apparatus according to claim 2,
wherein the machine learning model is generated by machine learning using voice data and information characterizing voice,
the one or more processors further;
outputs information characterizing voice, corresponding to the sound data to be classified, as the classification result, and
outputs information in which the classification result of the learning model classification means and the classification result of the condition classification means are combined, as a result of the classification.

4. A sound classification method comprising:
inputting sound data to be classified into a machine learning model generated by machine learning using sound data and teacher data that serve as training data, and outputting a classification result using an output result from the machine learning model;
classifying the sound data to be classified, based on information registered in advance, and outputting a classification result; and
classifying the sound data to be classified, based on the classification result of machine learning model and the classification result using the information.

5. The sound classification method according to claim 4,
wherein the sound data is voice data, and an identifier of a speaker is given to the sound data to be classified, and
in the classification based on the information registered in advance, the identifier given to the sound data is specified from the sound data to be classified, the specified identifier is referred to information registered in advance for each identifier, the information corresponding to the specified identifier is extracted, and the extracted information is output as the classification result.

6. The sound classification method according to claim 5,
wherein the machine learning model is generated by machine learning using voice data and information characterizing voice,
in the classification using the machine learning model, information characterizing voice, corresponding to the sound data to be classified, is output as the classification result, and
in the classification of the sound data to be classified, information in which the classification result of the machine learning model and the classification result using the information are combined, is output as a result of the classification.

7. A non-transitory computer-readable recording medium including a program recorded thereon, the program including instruction that cause a computer to carry out:
inputting sound data to be classified into a machine learning model generated by machine learning using sound data and teacher data that serve as training data, and outputting a classification result using an output result from the machine learning model;
classifying the sound data to be classified, based on information registered in advance, and outputting a classification result; and
classifying the sound data to be classified, based on the classification result of machine learning model and the classification result using the information.

8. The non-transitory computer-readable recording medium according to claim 7,
wherein the sound data is voice data, and an identifier of a speaker is given to the sound data to be classified, and
in the classification using the information, from the sound data to be classified, the identifier given to the sound data is specified, the specified identifier is referred to information registered in advance for each identifier, the information corresponding to the specified identifier is extracted, and the extracted information is output as the classification result.

9. The non-transitory computer-readable recording medium according to claim 8,
wherein the machine learning model is generated by machine learning using voice data and information characterizing voice,
in the classification using the machine learning model, information characterizing voice, corresponding to the sound data to be classified, is output as the classification result, and
in the classification of the sound data to be classified, information in which the classification result of the machine learning model and the classification result using the information are combined, is output as a result of the classification.
